(19) United States
(12) Patent Application Publication
(10) Pub. No.: US 2008/0159090 A1
(43) Pub. Date: Jul. 3, 2008

(54) OPTICAL PICKUP AND DISK DRIVE DEVICE

(75) Inventors: Kenya KUROKAWA, Fuchu-shi (JP); Makoto Nagasato, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/833,644

(22) Filed: Aug. 3, 2007

(30) Foreign Application Priority Data
Dec. 28, 2006 (JP) 2006-355147

(51) Int. Cl. G11B 7/00

(52) U.S. Cl. 369/44.23

(57) ABSTRACT

Disclosed is an optical pickup including: an actuator supporting a lens holder holding an objective lens and a yoke base including a predetermined insert and holding a magnet for driving magnetically the lens holder; a head base having an opening into which the insert of the yoke base is inserted formed, and supporting the actuator in a state where the insert is inserted into the opening; and a joint joining an edge of the opening formed in the head base and the insert of the yoke base inserted into the opening to each other.

### CROSSREFERENCE TO RELATED APPLICATIONS

This application is based upon and claims the benefit of priority from the prior Japanese Patent Application No. 2006-355147, filed on Dec. 28, 2006; the entire contents of which are incorporated herein by reference.

### BACKGROUND

1. Field of the Invention

The present invention relates to an optical pickup and a disk drive device to record and/or reproduce information using a disk medium such as an optical disk.

2. Description of the Related Art

With the recent spread of notebook PCs and transportable DVD reproducing apparatuses, optical disk drive devices mounted in these apparatuses and optical pickups embedded in these optical disk drive devices are required to be downsized and thinned.

For example, the optical pickup can be thinned by inserting an objective lens drive unit and a rising mirror into an opening formed in an optical base to a bottom surface of the optical base and attaching these parts to each other in this state (for example, see Patent Reference 1).

Here, the optical pickup of the above document suppresses the deflection of laser light in reflection due to vibration of the rising mirror by bonding the bottom surface of the rising mirror to the bottom surface of the optical base by a bonding adhesive to substantially improve the stiffness of a peripheral portion of the rising mirror, thereby stabilizing a servo characteristic.

[Patent Reference 1] JP-A 2005-302228 (KOKAI)

However, in the optical pickup of the above document, the opening with a relatively large size allowing the entire planar shaped portion of the objective lens drive unit to be inserted thereinto is formed in the optical base. Therefore, the mechanical strength of the optical base as a whole is not necessarily sufficient, and hence the above structure in which the rising mirror is bonded onto the optical base has a problem in terms of a vibration suppressing effect.

### SUMMARY

Hence, the present invention has been made in consideration of the above situation and has as its object to provide an optical pickup and a disk drive device capable of obtaining a good optical characteristic by effectively suppressing possible vibration of an optical system on the optical pickup.

An optical pickup according to an aspect of the present invention comprises: an actuator which supports a lens holder holding an objective lens and a yoke base having a predetermined insert and holding a magnet for driving magnetically the lens holder; a head base in which an opening into which the insert of the yoke base is inserted is formed and which supports the actuator in a state where the insert is inserted into the opening; and a joint which joins an edge of the opening formed in the head base and the insert of the yoke base inserted into the opening to each other.

Further, a disk drive device according to an aspect of the present invention is equipped with an optical pickup which comprises: an actuator which supports a lens holder holding an objective lens and a yoke base including a predetermined insert and holding a magnet for driving magnetically the lens holder; a head base in which an opening into which the insert of the yoke base is inserted is formed and which supports the actuator in a state where the insert is inserted into the opening; and a joint which joins an edge of the opening formed in the head base and the insert of the yoke base inserted into the opening to each other.

According to the present invention, the optical pickup and the disk drive device capable of obtaining the good optical characteristic by effectively suppressing the possible vibration of the optical system on the optical pickup can be provided.

### BRIEF DESCRIPTION OF THE DRAWINGS

FIG. 1 is a functional block diagram showing a disk drive device equipped with an optical pickup according to a first embodiment of the present invention.

FIG. 2 is a perspective view showing an external appearance of the disk drive device shown in FIG. 1.

FIG. 3 is a perspective view of the optical pickup mounted in the disk drive device shown in FIG. 1 seen from the upper surface side thereof.

FIG. 4 is a perspective view of the optical pickup shown in FIG. 3 seen from the bottom surface side thereof.

FIG. 5 is a perspective view showing an actuator included in the optical pickup shown in FIG. 3.

FIG. 6 is a perspective view showing a movable part of the actuator shown in FIG. 5.

FIG. 7 is a perspective view showing a state where the actuator is detached from the optical pickup shown in FIG. 3.

FIG. 8 is an exploded perspective view of the optical pickup shown in FIG. 3.

FIG. 9 is an enlarged view of a surrounding portion of a beam of a head base seen from the bottom surface side of the optical pickup shown in FIG. 3.

FIG. 10 is a view visualizing a vibration mode shape at 6.9 kHz when an objective lens actuator is tracking-driven on the optical pickup shown in FIG. 3 in a state without joints.

FIG. 11 is a view visualizing a vibration mode shape at 7.9 kHz when the objective lens actuator is tracking-driven on the optical pickup shown in FIG. 3 in the state without joints.

FIG. 12 is a graph showing measurement results of rotational vibration characteristics in the beam of the pickup in the state without joints and in a state with joints.

FIG. 13 is an exploded perspective view of an optical pickup according to a second embodiment of the present invention.

FIG. 14 is an enlarged view of a peripheral portion of a beam of a head base seen from the bottom surface side of the optical pickup shown in FIG. 13.

### DETAILED DESCRIPTION

### Description of Embodiments

Embodiments of the present invention will be described with reference to the drawings, but the drawings are presented only for illustrative purpose and do not limit the invention in any way.

The best mode for carrying out the present invention will be described below with reference to the drawings.

### First Embodiment

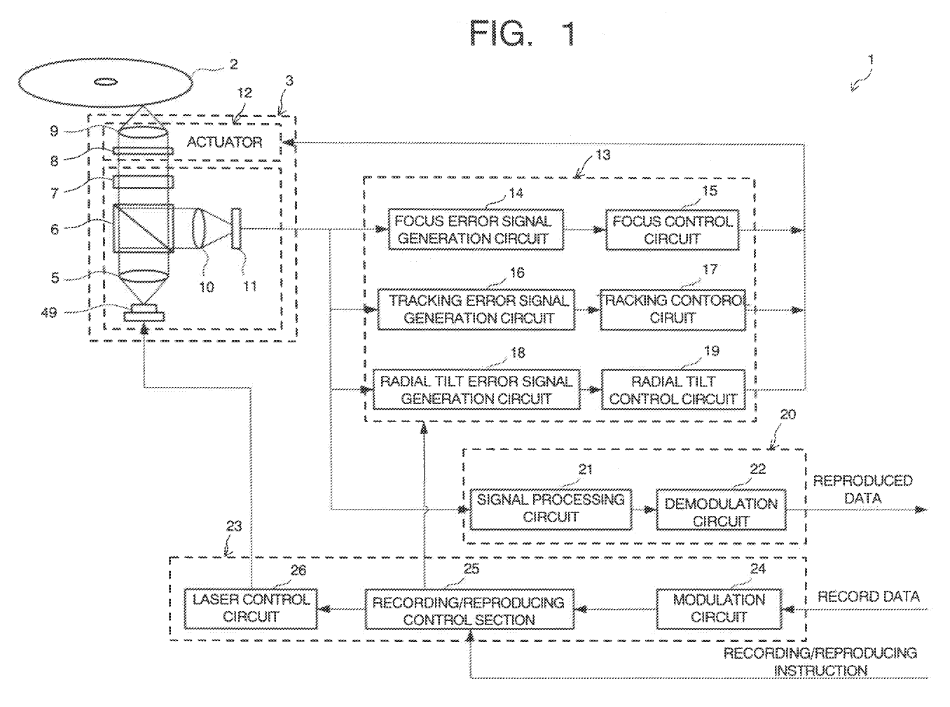

FIG. 1 is a functional block diagram showing a disk drive device 1 equipped with an optical pickup 3 according to a first embodiment of the present invention. Incidentally, in FIG. 1, an optical system in the optical pickup 3 is shown in a simplified manner.

First, mainly a control system of the disk drive device 1 of this embodiment will be described based on FIG. 1. The disk drive device 1 is an optical disk recording/reproducing device capable of recording and/or reproducing an optical disk 2 such as a CD (compact Disc), a DVD (Digital Versatile Dick), or an HD DVD (High Definition DVD), and as shown in FIG. 1, includes the optical pickup 3 being an optical head, a three-axis control section (three-axis drive control section) 13, a reproducing processing section 20, and a recording processing section 23.

As well as irradiating laser light to the optical disk 2 to record and reproduce information, the optical pickup 3 converts reflected light from the optical disk 2 into an electrical signal and outputs it as a reproduction signal, and includes as components of an optical system a laser diode 49, a lens 5, a PBS (polarizing beam splitter) 6, a rising mirror 7, an HOE (holographic optical element) 8, an objective lens 9, a condenser lens 10, and a photodetector 11.

Further, the optical pickup 3 includes an actuator (objective lens actuator) 12 equipped with the objective lens 9 and the HOE 8, and performs three-axis control on the objective lens 9 and the HOE 8 by the actuator 12. The three-axis control section 13 includes a focus error signal generation circuit 14, a focus control circuit 15, a tracking error signal generation circuit 16, a tracking control circuit 17, a radial tilt error signal generation circuit 18, and a radial tilt control circuit 19.

Control signals generated by these circuits included in the three-axis control section 13 are outputted to the actuator 12 to perform position control and attitude angle control of the objective lens 9. More specifically, focus control in which a separation distance between the objective lens 9 and a recording surface of the optical disk 2 is controlled so that the focus of the laser light is located exactly on the recording surface of the optical disk 2, tracking control in which the position in a radial direction of the objective lens is finely adjusted so that the focus of the laser light is always located at the center of a specific track of the optical disk 2, radial tilt control in which the attitude angle of the objective lens 9 is controlled in a radial direction of the optical disk 2 so that the laser light is always irradiated perpendicularly to the recording surface of the optical disk 2 even when the recording surface of the optical disk 2 tilts radially, slightly away from a plane perpendicular to an optical axis of the laser light are servo-controlled, respectively.

The reproducing processing section 20 performs reproducing processing on the signal outputted from the optical pickup 3, and includes a signal processing circuit 21 and a demodulation circuit 22. The recording processing section 23 mainly performs recording of information on the optical disk 2, and includes a modulation circuit 24, a recording/reproducing control section 25, and a laser control circuit 26.

Now, the basic operation of the disk drive device 1 will be described. First, the operation of recording information on the optical disk 2 will be described. The modulation circuit 24 of the recording processing section 23 modulates recording information (data symbol) provided from a host, for example, a main unit of a personal computer to a channel bit sequence based on a predetermined modulation scheme. The channel bit sequence corresponding to the recording information is inputted to the recording/reproducing control section 25.

A recording/reproducing instruction (recording instruction in this case) from the host is inputted to this recording/reproducing control section 25. The recording/reproducing control section 25 outputs a control signal to the three-axis control section 13 to drive the actuator 12 so that a light beam is properly focused on a target recording position. Further, the recording/reproducing control section 25 supplies the channel bit sequence to the laser control circuit 26. The laser control circuit 26 converts the channel bit sequence into a laser drive waveform to pulse-drive the laser diode 49. Consequently, the laser diode 49 generates a recording light beam corresponding to a desired bit sequence.

The recording light beam generated by the laser diode 49 is converted into collimated light by the lens 5, and enters and is transmitted through the PBS 6. The light beam transmitted through the PBS 6 is reflected by the rising mirror 7, transmitted through the HOE 8, and focused on the recording surface of the optical disk 2 by the objective lens 9. The focused recording light beam is maintained in a state where the best light beam spot can be obtained on the recording surface of the optical disk 2 by the focus control, tracking control, and radial tilt control by the three-axis control section 13 and the actuator 12.

Next, reproduction of information from the optical disk 2 by the disk drive device 1 will be described. A recording/reproducing instruction (reproducing instruction in this case) from the host is inputted into the recording/reproducing control section 25. The recording/reproducing control section 25 outputs a reproducing control signal to the laser control circuit 26 in accordance with the reproducing instruction from the host.

The laser control circuit 26 drives the laser diode 49 based on the reproducing control signal to generate a reproducing light beam. The reproducing light beam generated by the laser diode 49 is converted into collimated light by the lens 5, and enters and is transmitted through the PBS 6. The light beam transmitted through the PBS 6 is reflected by the rising mirror 7, transmitted through the HOE 8, and focused on the recording surface of the optical disk 2 by the objective lens 9. The focused reproducing light beam is maintained in the state where the best light beam spot can be obtained on the recording surface of the optical disk 2 by the focus control, tracking control, and radial tilt control by the three-axis control section 13 and the actuator 12.

The reproducing light beam irradiated onto the optical disk 2 is reflected by a reflective film or a reflective recording film within the recording surface. The reflected light is transmitted through the objective lens 15 in a reverse direction, converted into collimated light again, transmitted through the HOE 8, and thereafter reflected by the PBS 6 polarized perpendicularly to incident light. The light beam reflected by the PBS 6 is converted into convergent light by the condenser lens 10 and enters the photodetector 11. The photodetector 11 is constituted, for example, of a 4-split photodetector. The light beam which has entered the photodetector 11 is photoelectrically converted into an electrical signal, which is then amplified. The amplified signal is equalized and binarized by the signal processing circuit 21 of the reproducing processing section 20 and then sent to the demodulation circuit 22. The signal is subjected to a demodulation operation corresponding to the predetermined modulation scheme in the demodulation circuit 22, and then reproduced data is outputted.

On the other hand, part of the electrical signal outputted from the photodetector 11 is inputted to the three-axis control section 13, and a focus error signal is generated therefrom by the focus error signal generation circuit 14. Likewise, parts of the electrical signal outputted from the photodetector 11 are inputted to the three-axis control section 13, and a tracking error signal and a radial tilt error signal are generated therefrom, respectively, by the tracking error signal generation circuit 16 and the radial tilt error signal generation circuit 18.

The focus control circuit 15 controls the actuator 12 based on the focus error signal to control the focus of the beam spot. The tracking control circuit 17 controls the actuator 12 based on the tracking error signal to control the tracking of the beam spot. The radial tilt control circuit 19 controls the actuator 12 based on the radial tilt error signal to control the radial tilt of the beam spot. As just described, the actuator 12 controls the position and attitude angle of the objective lens 19 mounted in the actuator 12 based on the control signals from the three-axis control section 13 so as to maintain the optimal position of the beam sport with respect to the optical disk 2.

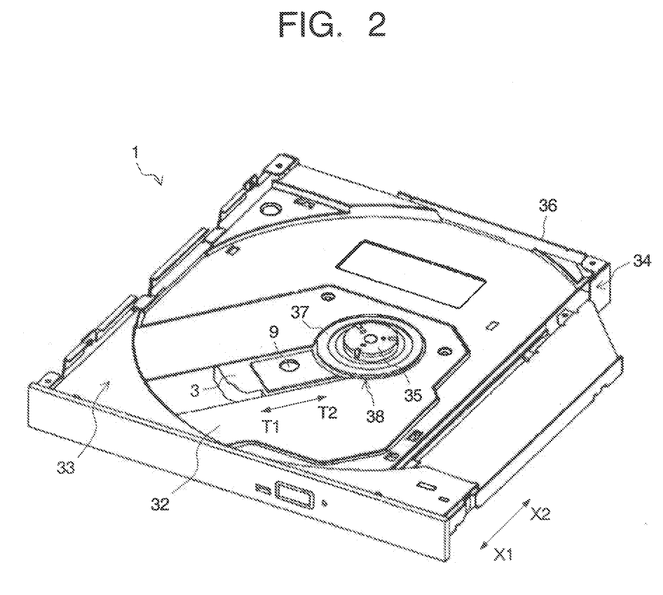

Next, the mechanical structure of the disk drive device 1 of this embodiment will be described. Here, FIG. 2 is a perspective view showing an external appearance of the disk drive device 1. As shown in FIG. 2, the disk drive device 1 of this embodiment is, for example, a thin drive device mounted in a notebook PC, a book PC, or the like. The disk drive device 1 is constituted of a drawer 33 with a built-in disk recording/reproducing unit 32 in which electronic components and mechanical components to record and reproduce information by rotationally driving the optical disk 2 are unitized, and a cabinet 34 capable of housing this drawer 33. The cabinet 34 is constituted of an upper cabinet (not shown) as an upper cover and a lower cabinet 36 provided with guide rails to allow the drawer 34 to be ejectable and retractable in directions indicated by arrows X1-X2.

The disk recording/reproducing unit 32 mounted in the drawer 33 is provided with a disk motor 38 rotationally driving a turntable 37 on which the optical disk 2 is placed, the above-mentioned optical pickup 3, and so on. The optical pickup 3 is carried in the radial direction (tracking directions T1-T2) of the optical disk 2 by a pickup feed mechanism constituted of a feed motor, plural reduction gear groups, and so on.

Further, a disk chucking mechanism 35 fixedly holding the optical disk 2 on the turntable 37 while centering it, and so on are attached to the above disk motor 38. These disk motor 38, optical pickup 3, pickup feed mechanism, and so on are mounted on a single mechanical chassis, and this mechanical chassis is supported in the drawer 33 via a vibration-proof member such as damper rubber by a floating structure.

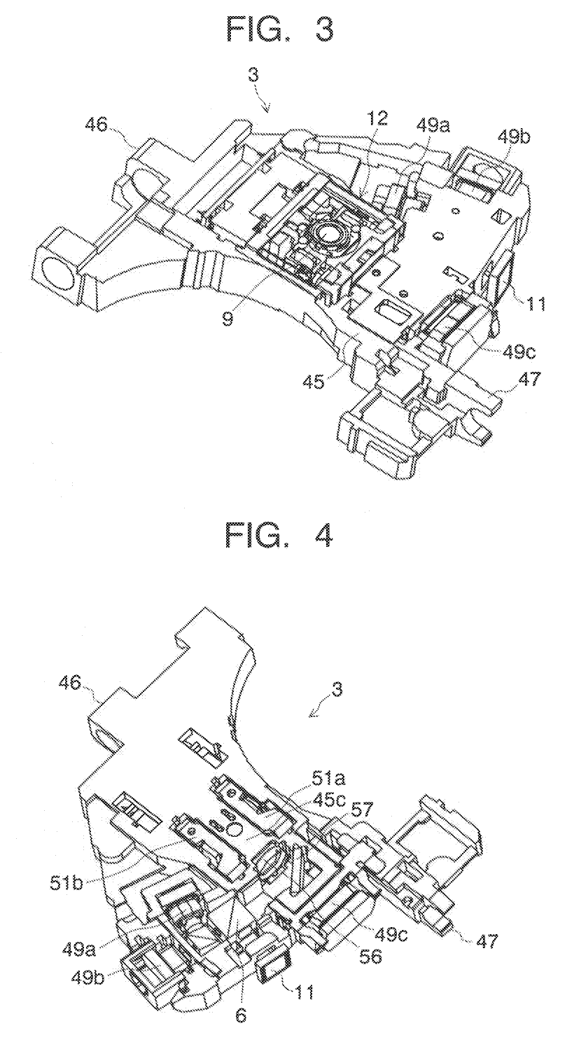

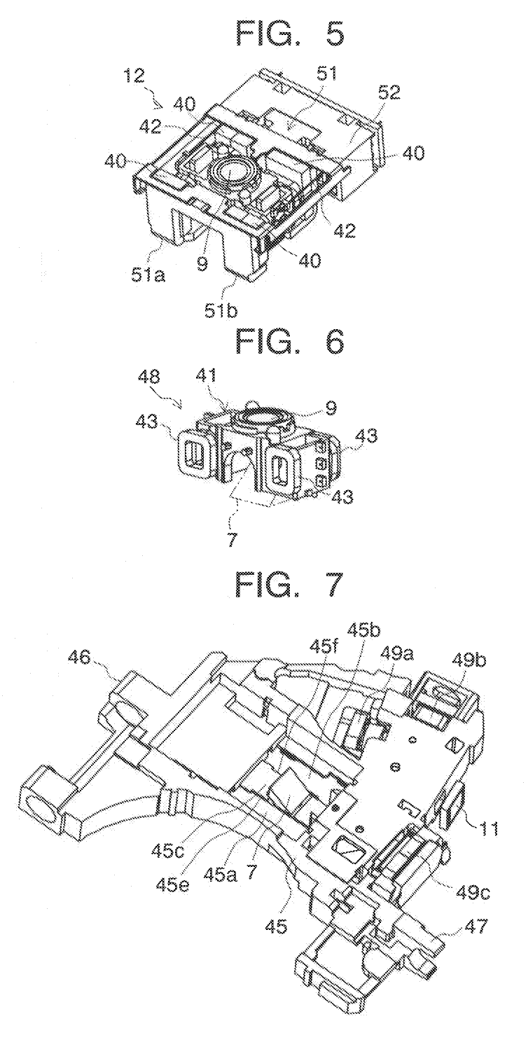

Next, the structure of the optical pickup 3 according to this embodiment will be described based on FIG. 3 to FIG. 7. Here, FIG. 3 is a perspective view of the optical pickup 3 seen from the upper surface side thereof (the side on which the objective lens 9 is exposed), and FIG. 4 is a perspective view of the optical pickup 3 seen from the bottom surface side thereof (the side on which the objective lens 9 is not exposed). Further, FIG. 5 is a perspective view showing the actuator 12 included in the optical pickup 3, and FIG. 6 is a perspective view showing a movable part 48 of the actuator 12 in FIG. 5. Furthermore, FIG. 7 is a perspective view showing a state where the actuator 12 is detached from the optical pickup 3 in FIG. 3.

Namely, as shown in FIG. 3 and FIG. 4, a head housing portion (pickup body) of the optical pickup 3 is formed by a head base 45 made of aluminum die cast, zinc die cast, or magnesium die cast to hold magnetic drive system components and optical system components. A main guide bearing 46 and a sub guide bearing 47 are formed in the head base 45. A main shaft (main guide shaft) and a countershaft (sub guide shaft) which guide the transfer of the optical pickup 3 are inserted through the main guide bearing 46 and the sub guide bearing 47, respectively. The main shaft and the countershaft are respectively supported on the mechanical chassis of the disk recording/reproducing unit 32.

As shown in FIG. 3 and FIG. 4, the actuator 12, the above rising mirror 7, the PBS 6, the collimator lens 56, a trichroic mirror 57, the photodetector 11, the above laser diode 49 irradiating predetermined laser light, and so on are mounted on the head base 45 while being bonded thereto. Here, the rising mirror 7 reflects the laser light, which is irradiated from the laser diode 4 and reflected by the trichroic mirror 57 through a predetermined optical system and then passes through the collimator lens 56, at a right angle and guides it to the objective lens 9 side. Further, on the head base 45 of the optical pickup 3 of this embodiment, three types of laser light sources of a DVD laser diode 49a, a HD DVD laser diode 49b, and a CD laser diode 40c are mounted as the laser diode 49.

As shown in FIG. 3, FIG. 4, and FIG. 6, the actuator 12 supports a lens holder 41 holding the objective lens 9 (and the HOE 8) and a yoke base 51 holding magnets 40 for driving magnetically the lens holder 41. As shown in FIG. 6, the lens holder 41 is formed in a hollow rectangular parallelepiped shape. The rising mirror 7 is placed below the objective lens 9 and surrounded by the lens holder 41. That is to say, in the actuator 12 of the optical pickup 3 of this embodiment, a so-called lens center-type lens holder 41 is used. Further, magnetic driving coils 43 are attached to the periphery of the lens holder 41. The magnetic driving coils 43 and the lens holder 41 holding the objective lens 9 constitute the movable part 48 which is movable with respect to a body of the actuator 12.

As shown in FIG. 3, FIG. 5, and FIG. 6, this movable part 48 is fixed to a gel box 52 via suspension wires 42. The gel box 52 is bonded to the above yoke base 51 made of magnetic metal such as SPCC or S45C. The magnets 40 are placed before and behind the movable part 48 and fixedly attached to the yoke base 51. Namely, the movable part 48 is supported in the air by the suspension wires 42 and can drive the objective lens 9 on the lens holder 41 with little influence of friction by Lorentz force generated by a magnetic field produced from the magnets 40 and an electric field produced by passing an electric current through the magnetic driving coils 43.

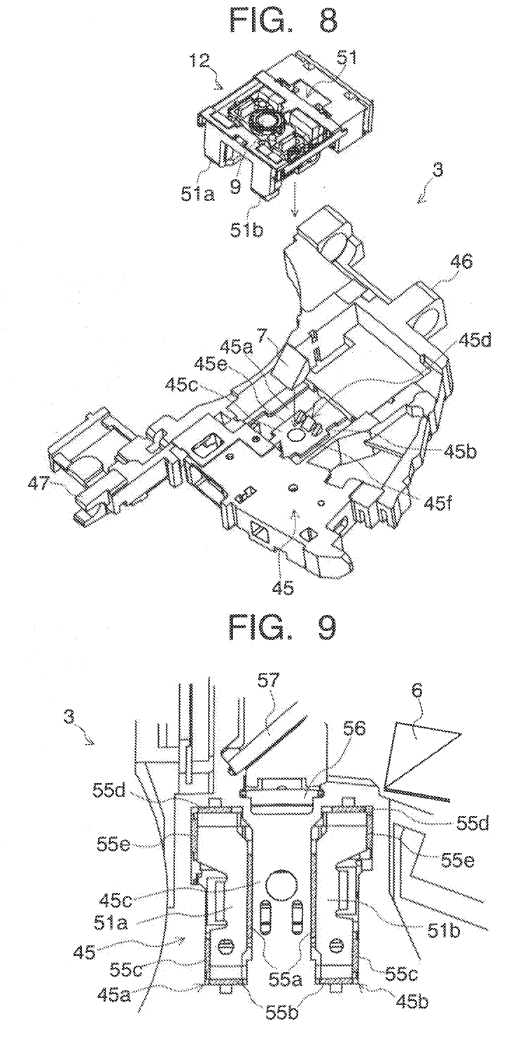

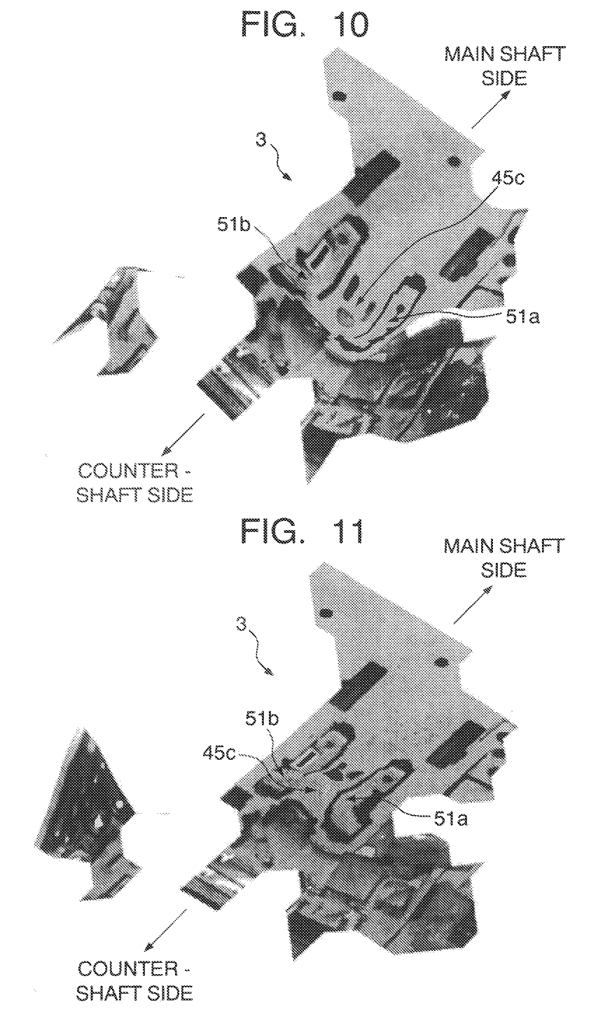

Next, the structure around the rising mirror 7 of the optical pickup 3 according to this embodiment will be described based on FIG. 8 to FIG. 12 in addition to FIG. 3 to FIG. 7 described above. Here, FIG. 8 is an exploded perspective view of the optical pickup 3, and FIG. 9 is an enlarged view of a surrounding portion of a beam 45c of the head base 45 seen from the bottom surface side of the optical pickup 3.

Namely, as shown in FIG. 4, FIG. 5, FIG. 8, and FIG. 9, the yoke base 51 is provided with a set (pair) of inserts 51a and 51b protruding respectively. On the other hand, as shown in FIG. 7 to FIG. 9, in the head base 45, a set (pair) of openings 45a and 45b into which the set of inserts 51a and 51b of the yoke base 51 are respectively inserted are formed. The head base 45 supports the actuator 12 in a state where the set of inserts 51a and 51b of the yoke base 51 are respectively inserted into the openings 45a and 45b. Further, on the head base 45, the beam 45c is formed at a position sandwiched between the set (pair) of openings 45a and 45b. As shown in FIG. 7 and FIG. 8, the rising mirror 7 is mounted (placed) near the openings 45a and 45b, that is, directly above the beam 45c. More specifically, the rising mirror 7 is joined onto the beam 45c while being positioned at a mirror receiver 45d provided on the beam 45c.

Here, to record/reproduce the optical disk 2 at high speed in the actuator 12, it is necessary to increase resonant frequency by increasing the stiffness of the lens holder 41 which supports the objective lens 9 and to increase drive sensitivity to drive the objective lens 9 quickly. Therefore, in this embodiment, the above lens center-type lens holder 41 is adopted.

Meanwhile, the average thickness of the head base 45 is formed to be 0.5 mm to 0.6 mm, but to thin a body of the optical pickup 3, the thickness of the above beam 45c is formed to be, for example, 0.3 mm. In other words, the beam 45c on which the rising mirror 7 is mounted can have neither a large width nor a large thickness due to the constraints of the sizes of the body of the optical pickup 3 and the actuator 12 and the like, so that its second moment of area becomes a small value. Hence, the beam 45c may resonate within several kHz (for example, a band from 2 kHz to 15 kHz) being the control band of the actuator 12. If the beam 45c resonates, the rising mirror 7 also vibrates greatly. In particular, when the rising mirror 7 vibrates in a radial tilt direction, the optical axis of the laser light which is guided to the objective lens 7 and the disk surface side while being reflected by the rising mirror 7 is deflected, which exerts a bad influence on an optical characteristic in general including a servo characteristic.

Hence, to suppress possible vibration of the rising mirror 7, as shown in FIG. 7 to FIG. 9, the optical pickup 3 of this embodiment includes joints 55a to 55e which join edges (peripheral edge portions) 45e and 45f of the set of openings 45a and 45b formed in the head base 45 and the set of inserts 51a and 51b of the yoke base 51 respectively inserted into the openings 45a and 45b to each other. Here, the above openings 45a and 45b are formed to have a size corresponding to that of the inserts 51a and 51b each being a portion of the yoke base 51 (actuator 12), so that the head base 45 functioning as a frame portion (housing portion) of the body of the optical pickup 3 can ensure mechanical strength as a housing.

To put it in detail, as shown in FIG. 4 and FIG. 9, opening ends of the openings 45a and 45b on the bottom surface side (the side on which the objective lens 9 is not exposed) of the head base 45 and front end surfaces of the respective inserts 51a and 51b of the yoked base 51 inserted into the openings 45a and 45b are formed to be in the same plane in a state where the inserts 51a and 51b are inserted into the openings 45a and 45b. The joints 55a to 55e are constituted by bonding the edges 45e and 45f of the opening ends of the openings 45a and 45b and peripheral edges of the front end surfaces of the respective inserts 51a and 51b in the same plane by a predetermined bonding adhesive. A bonding adhesive with high stiffness when cured is suitable as the bonding adhesive applied to these joints 55a to 55e. Further, such joints may be provided over the entire peripheral edges of the openings 45a and 45b. Furthermore, in these joints, it is desirable to avoid a joining state such that the inserts 51a and 51g are supported in a cantilever manner as much as possible and instead adopt a joining state such that the inserts 51a and 51b are supported in an at least doubly clamped cantilever manner.

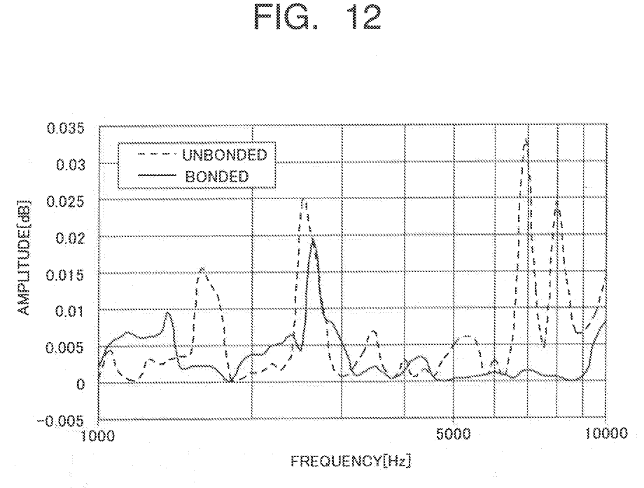

Now, a vibration suppressing effect by the joints 55a to 55e will be verified based on FIG. 10 to FIG. 12. FIG. 10 shows a result of measurement of a vibration mode shape near 6.9 kHz when the objective lens actuator mounted on the optical pickup 3 in an (unbonded) state without the joints 55a to 55e is tracking-driven. FIG. 11 shows a result of measurement of a vibration mode shape near 7.9 kHz when the objective lens actuator mounted on the optical pickup 3 in the state without the joints 55a to 55e is tracking-driven. Incidentally, in FIG. 10 and FIG. 11, a region where a large vibration occurs is converted into deformation as a display image being an inspection result and displayed in a visible manner. FIG. 12 shows results of measurement of rotational vibration characteristics in the beam 45c when the objective lens actuator of the optical pickup 3 is tracking-driven in the (unbonded) state without the joints 55a to 55e and a (bonded) state with the joints 55a to 55e.

Namely, it can be seen that the beam 45c which vibrates greatly at frequencies of 6.9 kHz and 7.9 kHz in the state without the joints 55a to 55e as shown in FIG. 10 to FIG. 12 significantly lowers its resonance peaks at frequencies equal to or higher than 6 kHz (especially near 6.9 kHz and 7.9 kHz) in the state with the joints 55a to 55e as shown in FIG. 12.

Accordingly, in the optical pickup 3 of this embodiment, the beam 45c of the head base 45 and the yoke base 51 supported by the actuator 12 are integrated, so that the second moment of area (stiffness) of all of components of a region supporting the rising mirror 7 improves, which can increase the resonant frequency of the whole structure supporting the rising mirror 7. Consequently, according to the optical pickup 3 and the disk drive device 1 equipped with this optical pickup 3 of this embodiment, the possible vibration of the optical system such as the rising mirror 7 on the optical pickup 3 can be effectively suppressed, thereby obtaining a good optical characteristic.

### Second Embodiment

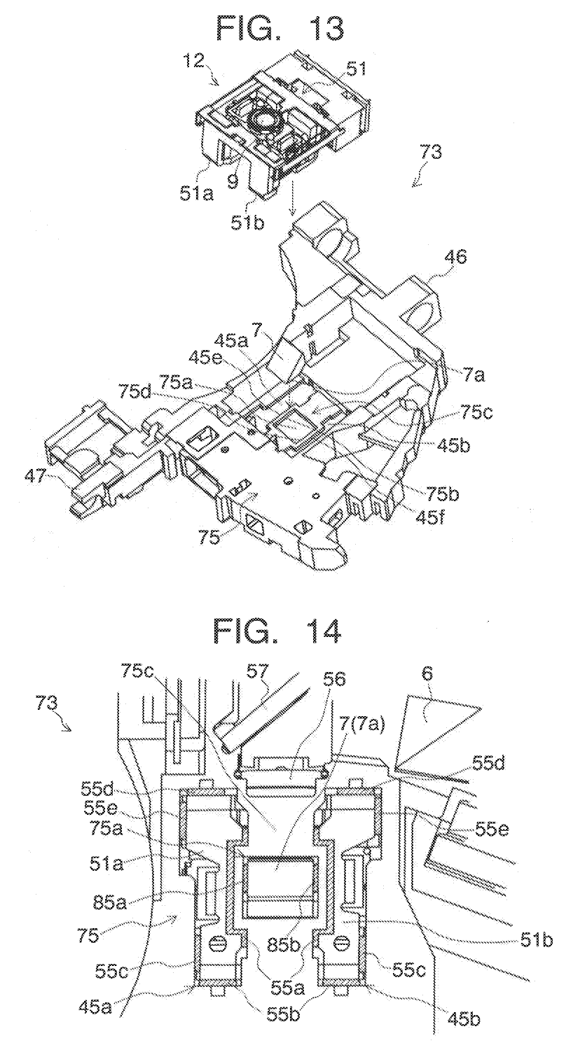

Next, a second embodiment of the present invention will be described based on FIG. 13 and FIG. 14. Here, FIG. 13 is an exploded perspective view of an optical pickup 73 according to the second embodiment of the present invention, and FIG. 14 is an enlarged view of a peripheral portion of a beam 75c in a head base 75 of the optical pickup 73 seen from the bottom surface side of the optical pickup 73. Incidentally, in this embodiment, in FIG. 13 and FIG. 14 above, the same reference numerals and symbols will be used to designate the same components as those provided in the optical pickup 3 of the first embodiment shown in FIG. 8 and FIG. 9, and a detailed description thereof will be omitted.

Namely, in the head base 75 of the optical pickup 73 according to this embodiment, an opening 75a (second opening) into which an insert 7a provided in the rising mirror 7 is inserted is formed in the beam 75c. Further, the optical pickup 73 includes joints (second joints) 85a and 85b which joins edges 75b and 75d of the opening 75a formed in the beam 75c and the insert 7a of the rising mirror 7 inserted into the opening 75a to each other.

To put it in detail, as shown in FIG. 13 and FIG. 14, the head base 45 and the rising mirror 7 are joined through the joints 85a and 85b so that an opening end of the opening 75a on the bottom surface side (the side on which the objective lens 9 is not exposed) of the head base 45 and a front end surface of the insert 7a inserted into the opening 75a are in the same plane. The joints 85a and 85b are constituted by bonding the edges 75b and 75d of the opening ends in the rectangular hole-shaped opening 75a and a set of sides facing each other of the front end surface of the sectional rectangle-shaped insert 7a of the rising mirror 7 in the same plane by a predetermined bonding adhesive. A bonding adhesive with high stiffness when cured is suitable as the bonding adhesive applied to these joints 85a and 85b, and such joint may be provided over the entire peripheral edge of the opening 75a.

Accordingly, also in the optical pickup 73 according to this embodiment, the stiffness of all of components of the region supporting the rising mirror 7 improves, which can increase the resonant frequency of the whole structure supporting the rising mirror 7. Consequently, according to the optical pickup 73 and the disk drive device equipped with this optical pickup 73, the possible vibration of the optical system on the optical pickup 73 can be effectively suppressed, thereby exhibiting an excellent optical characteristic. Further, in this embodiment, the rising mirror 7 can be mounted on the head base 45 with its insert 7a being inserted, so that the optical pickup 73 can be downsized and thinned by the height of the insert 7a.

While the present invention has been specifically described above using the first and second embodiments, the present invention is by no means limited only to these embodiments and can be modified in various ways without departing from the spirit of the present invention. For example, in the above embodiments, the optical pickup and the optical disk drive device to record/reproduce the optical disk has been described, but the present invention is also applicable to a pickup (optical head) to record/reproduce a magnetic optical disk such as an MD (Mini Disc) or an MO (Magneto-Optical disk) and a drive device equipped with this pickup.

Further, the first and second embodiments have exemplified the aspect in which in the state where the set of inserts of the yoke base are inserted into the set of openings of the head base, they are joined to each other, but instead of this, the numbers of openings of the head base and inserts of the yoke base may be each one or may be each three or more.

It is to be understood that the present invention is not intended to be limited to the particular embodiments shown and described herein, but covers all such modifications as would fall within the scope of the following claims.

What is claimed is:

1. An optical pickup, comprising:
an actuator supporting a lens holder holding an objective lens and a yoke base including a predetermined insert, the yoke base holding a magnet for driving magnetically the lens holder;
a head base having an opening into which the insert of the yoke base is inserted formed, and supporting the actuator in a state where the insert is inserted into the opening; and
a joint joining an edge of the opening formed in the head base and the insert of the yoke base inserted into the opening to each other.

2. The optical pickup according to claim 1,
wherein the head base supports a light source irradiating laser light and a rising mirror placed near the opening and guiding the laser light irradiated from the laser light source to a side of the objective lens.

3. The optical pickup according to claim 1,
wherein the head base includes a pair of openings as the opening and supports a light source irradiating laser light and a rising mirror mounted on a beam on the head base sandwiched between the pair of openings, the rising mirror guiding the laser light irradiated from the laser light source to a side of the objective lens.

4. The optical pickup according to claim 1,
wherein the head base supports a light source irradiating laser light and a rising mirror guiding the laser light irradiated from the laser light source to a side of the objective lens, and includes a second opening into which an insert provided at the rising mirror is inserted,
the optical pickup further comprising a second joint joining an edge of the second opening included in the head base and the insert of the rising mirror inserted into the second opening to each other.

5. The optical pickup according to claim 1,
wherein the head base includes a pair of openings as the opening, supports a light source irradiating laser light and a rising mirror mounted on a beam on the head base sandwiched between the pair of openings, the rising mirror guiding the laser light irradiated from the laser light source to a side of the objective lens, and includes in the beam a second opening into which an insert provided at the rising mirror is inserted,
the optical pickup further comprising a second joint joining an edge of the second opening in the beam and the insert of the rising mirror inserted into the second opening to each other.

6. A disk drive device equipped with an optical pickup,
wherein the optical pickup comprises:
an actuator supporting a lens holder holding an objective lens and a yoke base including a predetermined insert, the yoke base holding a magnet for driving magnetically the lens holder;
a head base having an opening into which the insert of the yoke base is inserted formed, and supporting the actuator in a state where the insert is inserted into the opening; and
a joint joining an edge of the opening formed in the head base and the insert of the yoke base inserted into the opening to each other.

7. The disk drive device according to claim 6,
wherein the head base supports a light source irradiating laser light and a rising mirror placed near the opening and guiding the laser light irradiated from the laser light source to a side of the objective lens.

8. The disk drive device according to claim 6,
wherein the head base includes a pair of openings as the opening and supports a light source irradiating laser light and a rising mirror mounted on a beam on the head base sandwiched between the pair of openings, the rising mirror guiding the laser light irradiated from the laser light source to a side of the objective lens.

9. The disk drive device according to claim 6,
wherein the head base supports a light source irradiating laser light and a rising mirror guiding the laser light irradiated from the laser light source to a side of the objective lens, and includes a second opening into which an insert provided at the rising mirror is inserted; and
wherein the optical pickup further comprises a second joint joining an edge of the second opening included in the head base and the insert of the rising mirror inserted into the second opening to each other.

10. The disk drive device according to claim 6,
wherein the head base includes a pair of openings as the opening, supports a light source irradiating laser light and a rising mirror mounted on a beam on the head base sandwiched between the pair of openings, the rising mirror guiding the laser light irradiated from the laser light source to a side of the objective lens, and includes in the beam a second opening into which an insert provided at the rising mirror is inserted; and
wherein the optical pickup further comprises a second joint joining an edge of the second opening in the beam and the insert of the rising mirror inserted into the second opening to each other.
